(19) United States
(12) Patent Application Publication
(10) Pub. No.: US 2026/0017619 A1
(43) Pub. Date: Jan. 15, 2026

(54) LITIGATION DOCKETING SOFTWARE WITH RETRIEVAL FROM COURT DATABASES AND AUTOMATED EVENT CORRECTION

(71) Applicant: Strategic Legal Practices, APC, Los Angeles, CA (US)

(72) Inventors: Payam Shahian, Los Angeles, CA (US); Shawn P. Pauli, Los Angeles, CA (US)

(21) Appl. No.: 19/226,921

(22) Filed: Jun. 3, 2025

Related U.S. Application Data
(60) Provisional application No. 63/669,671, filed on Jul. 10, 2024.

(51) Int. Cl. G06Q 10/1093; G06F 9/54; G06F 16/23; G06Q 50/18; G06Q 50/26

(52) U.S. Cl. CPC G06Q 10/1093; G06F 9/542; G06F 16/2365; G06Q 50/18; G06Q 50/26

(57) ABSTRACT

A docketing system may send for display in a user interface a docket of events corresponding to actions to be performed for a legal court case. The system may receive, from an API notification channel of a Legal Data-as-a-Service (LDaaS) system, a data structure associated with court records issued by a court facilitating the legal court case. The system may extract an event from the data structure received from the LDaaS system. The system may match the extracted event to an event in the docket by accessing a mapping table. The system may subsequent to identifying a discrepancy between the extracted event and the matched event in the docket, update the event in the docket based on information of the extracted event. The system may automatically send instructions to the user interface to update the matched event displayed in the user interface to be the updated event in the docket.

### CROSS-REFERENCE TO RELATED APPLICATION

This application claims priority to, and the benefit of, U.S. Provisional Patent Application 63/669,671, filed on Jul. 10, 2024, which is incorporated herein by reference in its entirety.

### BACKGROUND

### 1. Technical Field

This disclosure relates to improved user interfaces and systems for automatic docket management and event updating within a legal case management system.

### 2. Description of Related Art

The legal industry heavily relies on efficient and accurate case management. Law firms handle numerous cases simultaneously, each with critical deadlines, court filings, client communications, and billing requirements. To effectively manage this complexity, law firms have historically employed docketing systems.

### BRIEF DESCRIPTION OF THE DRAWINGS

Embodiments of the disclosure have other advantages and features which will be more readily apparent from the following detailed description and the appended claims, when taken in conjunction with the examples in the accompanying drawings, in which:

FIG. 1 illustrates one embodiment of a system environment for implementing a docketing system, in accordance with an embodiment.

FIG. 2 is a block diagram of example modules and databases of docketing system, in accordance with an embodiment.

FIGS. 3A and 3B illustrate a docketing system user interface showing a list of matters, in accordance with an embodiment.

FIG. 4 is a docketing system user interface showing a matter schedule.

FIGS. 5A and 5B illustrate an example docket system matching user interface, in accordance with an embodiment.

FIG. 6 is a user interface illustrating example mappings of mapping module, in accordance with an embodiment.

FIGS. 7A and 7B illustrate another example matching user interface, in accordance with an embodiment.

FIG. 8 is a zoomed in view of the left pane of a matching user interface, in accordance with an embodiment.

FIG. 9 is a magnified view of an upper left portion of a matching user interface, in accordance with an embodiment.

FIG. 10 is another magnified view of an upper left portion of a matching user interface, in accordance with an embodiment.

FIG. 11 is a block diagram illustrating components of an example machine for reading and executing instructions from a machine-readable medium, in accordance with one or more example embodiments.

FIG. 12 is a flow chart illustrating a method for improved user interfaces and systems for automatic docket management and event updating within a legal case management system, in accordance with an embodiment.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

### Configuration Overview

Traditional docketing systems, often manual or semi-automated, have served the purpose of tracking deadlines and key events in a case's lifecycle. However, these legacy systems often present technical challenges in the context of modern, distributed computing environments. For instance, traditional docketing systems frequently operate in isolation, requiring manual data entry and updates from other law firm internal applications or external applications. This lack of integration leads to data inconsistencies, potential errors, and increased administrative overhead.

Moreover, as law firms grow and handle larger caseloads, legacy docketing systems may struggle to scale effectively. These systems may not be able to handle increased data volumes, leading to performance issues and limited functionality. Still further, traditional docketing systems may lack advanced features such as automated reminders, intelligent deadline calculations, and integration with external databases. They also lack technical features, such as intelligent event correlation, automated reconciliation mechanisms, or scalable APIs for integrating structured court data. These limitations restrict the ability of law firms to leverage technology to improve efficiency and decision-making and reduce manual errors. The challenges highlight the need for innovative docketing software solutions that can address these limitations and provide law firms with a more efficient, integrated, and scalable approach to case management.

Embodiments described herein may provide technical solutions to these problems by implementing an automated, scalable docketing system with real-time integration to external legal data sources. Some embodiments relate to a docketing system and method for tracking deadlines related to a case (e.g., a case before a federal court, a state court, a bankruptcy court, an appellate court, a local court, a government agency, and the like) and checking events upon which the deadlines are generated against court records. The docketing system may receive information about a new case and one or more court events that may be manually entered into the system. The system periodically uses one or more application programming interfaces (APIs) to call information from one or more court databases about court events related to each case (e.g., from a Legal Data-as-a-Service (LDaaS) system). The docketing system automatically checks the retrieved events against the manually entered events. When a mismatch is found, the docketing system checks a mapping table to attempt to correct the mismatch. If a mapping exists between the mismatched entries, the docketing system automatically corrects the case docket; otherwise, the system prompts a user to create a new mapping, which is then stored in the mapping table. The system can then automatically correct future instances of the same type of mismatch based on the new mapping stored in the mapping table, thereby improving long-term accuracy and system efficiency.

The docketing system described herein offers significant technical advantages by integrating real-time data retrieval from court databases (via the LDaaS system), thereby reducing manual data entry and reducing the risk of data inconsistencies and errors. The system's automated features, such as intelligent deadline calculations and event mapping, enhance the efficiency and accuracy of managing case dockets. Additionally, the integration with LDaaS systems enables comprehensive access to normalized court records by adapting to non-uniform data schemas, further boosting the reliability of the docketing process.

The docketing system's user interfaces enhance accuracy and efficiency in managing court records and deadlines. These interfaces are structured to provide real-time automatic updates based on ground truth determinations made from information and updates from the LDaaS system, thus enabling users to access and manage dockets with reduced manual input and reduced risk of errors. For example, the system automatically receives an API payload from an API channel with the LDaaS system. The API payload includes new data about a legal case. The system identifies that case and checks court event data in the payload against the local data. To do this, the system may use a mapping table to map events or event types received from the LDaaS system to events or event types maintained by the docketing system. For example, the docketing system compares dates and case names to identify a case in a local docket. As another example, the docketing system may use a case identifier to identify the case in the local docket that the data structure received from the LDaaS system belongs to. When updating the local docket using the received data structure, the docketing system may use a mapping table for an unmatched event (e.g., an event in the data structure that does not match any event in the local docket). The mapping table may specify mappings between an event type in a court docket to how that event type is referenced to in the local docket. If a match is found in the table, then updates or information from the API payload can be used to (e.g., automatically) update or correct an event maintained by the docketing system. Thus, a user interface of the docketing system may be (e.g., automatically) updated (e.g., in real-time) based on ground truth information from the LDaaS system to improve the accuracy of displayed docket events.

Other aspects include components, devices, systems, improvements, methods, processes, applications, computer readable mediums, and other technologies related to any of the above.

### Overview

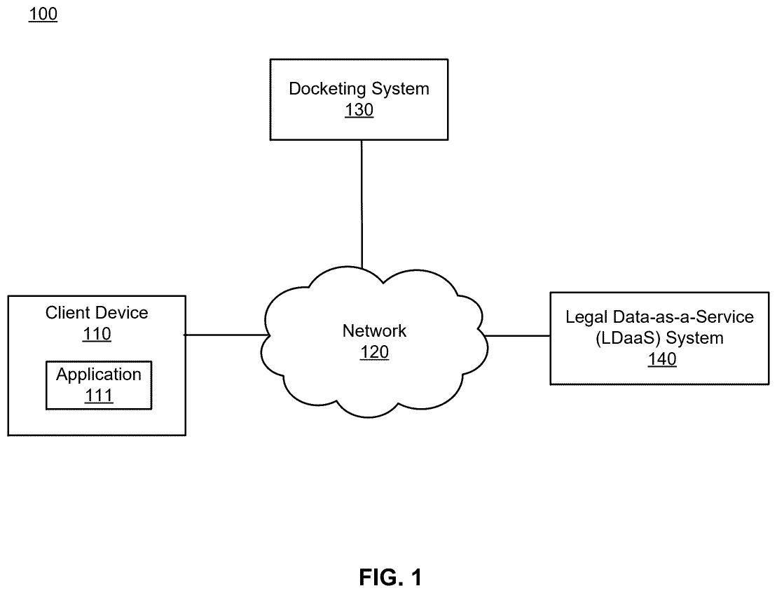

FIG. 1 illustrates one embodiment of a system environment for implementing a docketing system, in accordance with an embodiment. As depicted in FIG. 1, environment 100 includes client device 110 (with application 111 installed thereon), network 120, docketing system 130, and LDaaS system 140 (“LDaaS” is an abbreviation for Legal Data-as-a-Service). While only one instance of each item is depicted, this is for illustrative convenience, and references in the singular to each item is meant to cover instances where plural items exist.

Client device 110 is a device with which a user may interface with docketing system 130. Client device 110 may be any device having a user interface and capable of communication with docketing system 130. For example, client device 110 may be a personal computer, laptop, tablet, wearable device, kiosk, smart phone, or any other device having components capable of performing the functionality disclosed herein.

Optionally, client device 110 may have application 111 installed thereon. Application 111 may provide an interface between client device 110 and docketing system 130. Application 111 may be a stand-alone application installed on client device 110 that is communicatively coupled with docketing system 130 to perform at least some of the activity described with respect to docketing system 130 on client device 110, or may be accessed by way of a secondary application, such as a browser application. Any activity described herein with respect to docketing system 130 may be performed wholly or in part (e.g., by distributed processing) by application 111. That is, while activity is primarily described as performed in the cloud by docketing system 130, this is merely for convenience, and all of the same activity may be performed wholly or partially locally to client device 110 by application 111. Exemplary activity of application 111 may include providing a user interface to a user, receiving responses, and transmitting those responses for further processing by docketing system 130.

Network 120 facilitates transmission of data between client device 110, docketing system 130, and LDaaS system 140, as well as any other entity with which any entity of environment 100 communicates. Network 120 may be any data conduit, including the Internet, short-range communications, a local area network, wireless communication, cell tower-based communications, or any other communications.

LDaaS system 140 stores and provides access to (e.g., comprehensive and normalized) court records from one or more court systems corresponding to federal, state, or local courts, or government agencies. LDaaS system 140 may maintain its database by obtaining court records directly from court databases and other legal entities. LDaaS system 140 may provide docketing system 130 real-time or near real-time access to the stored data (e.g., via APIs). LDaaS system 140 is further described below.

Although LDaaS system 140 is illustrated as a single entity in FIG. 1, LDaaS system 140 may be multiple entities. Furthermore, although descriptions herein refer to docketing system 130 interacting with a single LDaaS system, docketing system 130 may interact with multiple LDaaS systems (e.g., if different LDaaS systems store information for different court cases).

Docketing system 130 is a docketing management system. Docketing system 130 receives (e.g., real-time) legal data from LDaaS system 140 and inputs from via client device 110 via network 120. Among other advantages, docketing system 130 provides enhanced accuracy and efficiency in managing court records and deadlines. Docketing system 130 may additionally, or alternatively, provide improved user interfaces (for display via client device 110) for accurately and efficiently managing dockets. Docketing system 130 may have its functionality distributed across any number of servers, and may have some or all functionality performed by local to client devices using application 111. Further details about docketing system 130 and LDaaS system 140 are disclosed below with respect to the remaining figures.

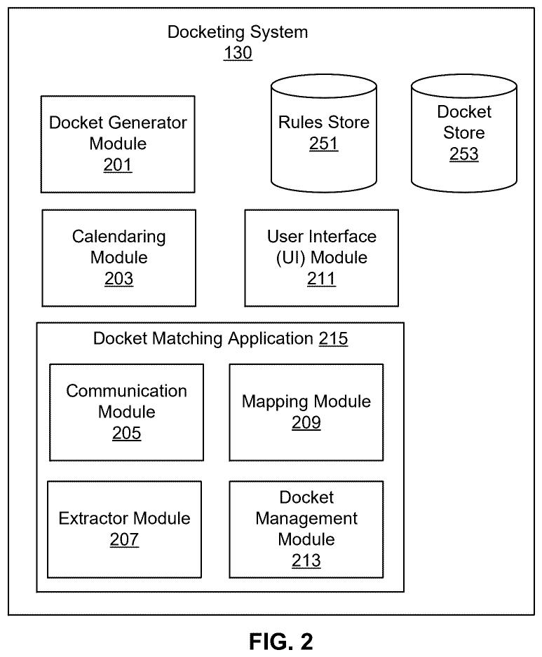

FIG. 2 is a block diagram of example modules and databases of docketing system 130, in accordance with an embodiment. As depicted in FIG. 2, docketing system 130 may include docket generator module 201, calendaring module 203, communication module 205, extractor module 207, mapping module 209, docket management module 213, UI module 211, rules store 251, and docket store 253. The modules and databases depicted in FIG. 2 are merely exemplary; fewer or additional modules and/or databases may be used to achieve the functionality disclosed herein.

Docket generator module 201 creates a docket of events for a legal court case. An event corresponds to an action to be performed for the court case. Docket generator module 201 may create an event from a user entering information for an event or by automatically extracting details from court databases and relevant case documents (e.g., via communication module 205 and extractor module 207). A deadline for an event may be entered by a user or automatically determined by calendaring module 203.

A matter, docket, or event generated, stored, and/or maintained by docketing system 130 may be referred to as a “local” or “internal” matter, docket, or event, as opposed to a “remote” or “external” matter, docket, or event from a court or LDaaS system 140. Thus, as described elsewhere, docketing system 130 may use information from external events as ground truth to verify or update internal events.

Calendaring module 203 (e.g., also referred to as a calendaring system), is an automated tool that utilizes a comprehensive database of court rules stored in store 251 to calculate deadlines and track events for legal matters. It can eliminate manual calculations and reduces errors by integrating real-time court data and automatically generating deadlines based on specific jurisdiction rules. In some embodiments, calendaring module 203 and/or rules store 251 is not part of docketing system 130 but can be accessed by docketing system 130 (e.g., via docket generator module 201) through network 120.

Communication module 205 is designed to retrieve court case information from LDaaS system 140 (e.g., in the form of a data structure) to help ensure the docketing system 130 remains updated with the latest court data (e.g., notifications about new filings, scheduled hearings, and deadlines). This module may utilize a series of standardized API calls or webhooks to request specific data structure sets from LDaaS system 140, such as case details, deadlines, and associated events. For example, communication module 205 establishes an API notification channel with LDaaS system 140. An API is a set of protocols, routines, and/or tools that allow communication module 205 to communicate with LDaaS system 140. An API may define the methods and data formats that the modules/systems can use to request and exchange information, e.g., to enable seamless integration and functionality across different systems/modules. To retrieve information, communication module 205 may send a query to LDaaS system 140, which processes the request and returns the information in real-time or near real-time, depending on the complexity of the query and the current system load. Communication module 205 may pull information periodically or responsive to receiving a notification from LDaaS system 140 indicating an update to a court case.

Extractor module 207, mapping module 209, and docket management module 213 may be collectively referred to as docket matching application 215.

Extractor module 207 extracts an event from data structures received from LDaaS system 140. For example, extractor module 207 receives a Javascript Object Notation (JSON) file, examines the file, and extracts one or more events from the JSON file.

Mapping module 209 receives an event extracted from extractor module 207 and maps it to an event in a docket. To map events, mapping module 209 may use predefined or standardized mappings (e.g., in a mapping table) that link event types in court records with corresponding event types of docketing system 130. Said differently, these mappings define the relationships between internal event types in docketing system 130 and their corresponding external representations in LDaaS system 140, helping docketing system 130 to perform accurate translations. If mapping module 209 is unable to find a matching event (e.g., for an external event) even after consulting the mapping table, the unmatched event may be displayed to the user via a user interface to enable a user to specify a mapping with a corresponding existing event (e.g., a local event) or to create a new local event in the docketing system 130 for the matched case. If a mapping is received from the user, mappings of mapping module 209 (e.g., the mapping table) may be updated for future mapping operations. In other situations, if there is no corresponding event, then docket management module 213 may generate a new event for the docket based on the information of the unmatched event. An event type may refer to a categorization of an event based on its nature or the action it represents within a legal court case. Examples include court hearings, deadlines for filings, or scheduled meetings.

Docket management module 213 reviews mappings determined by mapping module 209 for consistency. Docket management module 213 may verify or validate the mapped data. For example, docket management module 213 checks for discrepancies between a docket event and the mapped extracted event, identifying any mismatches. When a mismatch is identified, docket management module 213 may take steps to correct the errors, thereby enhancing the accuracy of the overall docket. If a discrepancy is identified, docket management module 213 can perform operations to correct the discrepancy, such as updating information of a local event to accurately reflect information of the correspondingly mapped external event.

Among other advantages, modules such as communication module 205, extractor module 207, mapping module 209, and docket management module 213 help ensure dockets of docketing system 130 remain consistent and reliable. For example, docketing system 130 ensures that the events and deadlines within a docket accurately reflect external data sources (e.g., LDaaS system 140), such as court databases and documents.

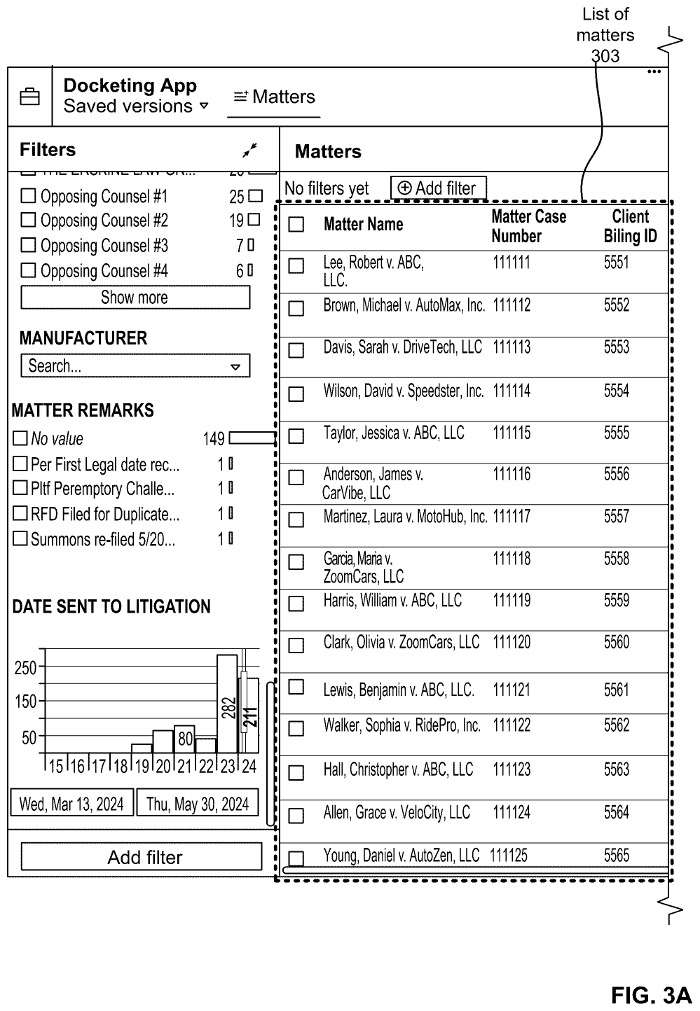

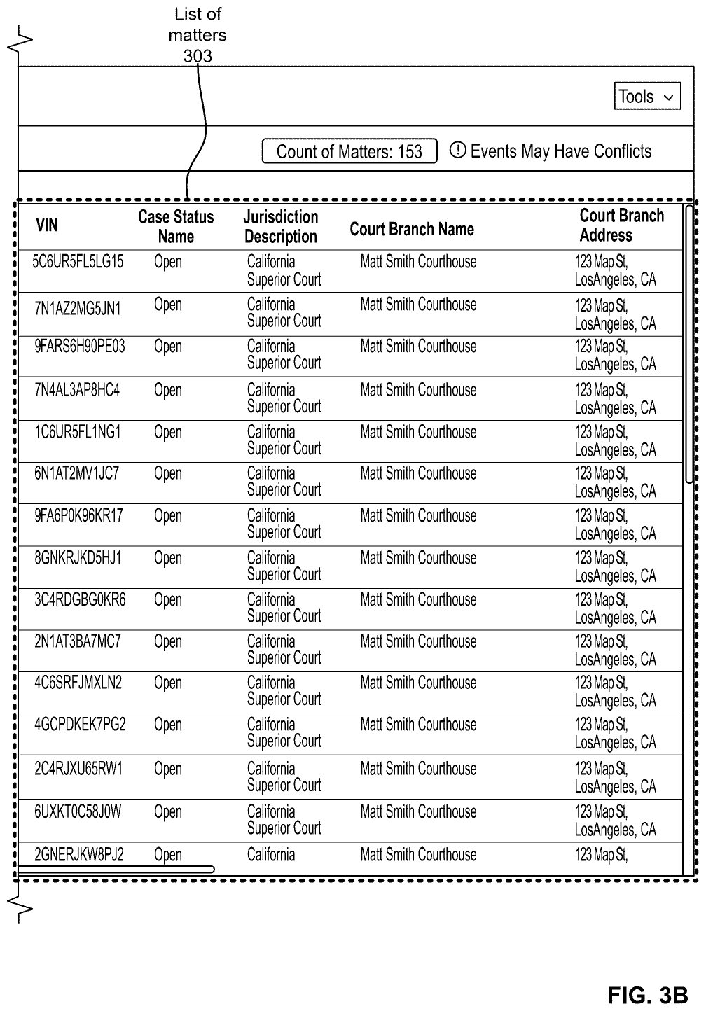

UI module 211 can generate a UI through which a user can interact with docketing system 130. A UI from UI module 211 may be displayed to a user on client device 110. UI module 211 may update generated UIs in response to user interactions or instructions (e.g., from docket management module 213). Example UIs generated and updated by UI module 211 are illustrated in FIGS. 3-10.

Docket store 253 stores events for a docket of a legal court case (e.g., generated by docket generator module 201). Models of docketing system 130 may access events stored in docket store 253.

Modules and stores of docketing system 130 are further described below with respect to the remaining figures.

In some embodiments, docketing system 130 communicates (e.g., via an API) with an artificial intelligence (AI) system (e.g., with a Large Language Model (LLM)) in addition to, or alternative, to communicating with LDaaS system 140 e.g., to enhance its data processing and event management functionalities. For example, docketing system 130, instructs the AI system to retrieve and/or process court records from LDaaS system 140. In another example, an LLM is used to assist interpreting legal documents, identifying relevant events or deadlines from court documents, converting unstructured data into structured formats compatible with system 130. In some embodiments, the LLM analyzes historical docketing data to suggest probable mappings for unmatched events based on contextual similarities or usage patterns. An AI system facilitate natural language queries from users (e.g., via client device 110), allowing them to interact with the docketing system 130 intuitively, such as by asking for case-specific deadlines or summaries. Among other advantages, use of an AI system may help automate the categorization of legal events, reduce manual input errors, and improve the accuracy of docket updates by cross-referencing extracted data with past patterns or predefined rules stored in the system 130.

### Docket Creation

The docketing system 130 may allow users (e.g., via client device 110) to manually create docket entries for a specific matter (e.g., corresponding to a court case). FIGS. 3A and 3B (“FIG. 3” collectively) illustrate a docketing system user interface showing a list of matters 303, in accordance with an embodiment (FIG. 3A is the left side of the user interface and FIG. 3B is right side of the user interface). As illustrated in FIG. 3, the docketing system UI may list all matters and include features allowing a user to filter and identify a specific matter. For a specific selected matter, the docketing system UI may enable a user of the docketing system to create a docket by adding one or more docket events.

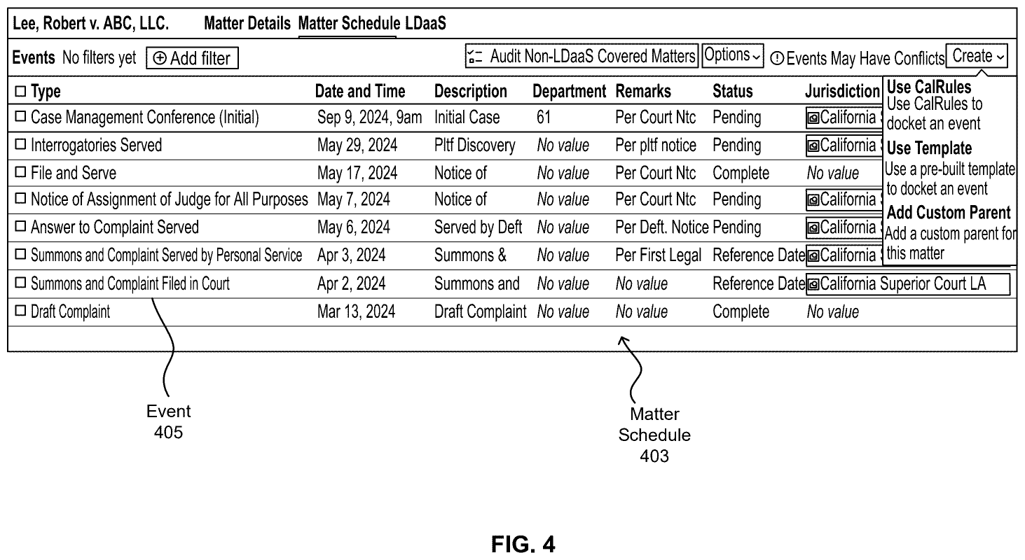

FIG. 4 is a docketing system user interface showing a matter schedule 403. Matter schedule 403 is a list of events (including event 405) for a docket of a matter. In the example of FIG. 4, matter schedule 403 includes columns describing the date and time, description, department, remarks, status, and jurisdiction for each event.

A user may add one or more docket events for a specific matter under a matter schedule tab. For example, based on correspondence received from a court, a user of the docketing system may create a new matter including matter number, matter name and the like, or the user may identify a particular matter the correspondence belongs to based on, e.g., case matter number or case name and jurisdiction. The user can then add an event (e.g., court action, parent event, or trigger) for the identified or created matter (e.g., event 405). The user can configure properties for the new event such as a name or type of the event, event deadline date and time, description, and the like.

FIG. 4 also shows that the user can use an automated court-rule based calendaring system (also referred to as calendaring module 203) to create (a) an event in a docket for a selected matter or (b) a docket including one or more events for a selected matter (e.g., by selecting “CalRules” in FIG. 4, which is an abbreviation for “CalendarRules”). The automated court-rule based calendaring system may utilize a vast database (e.g., rules store 251) of court rules and procedures from various jurisdictions. By identifying events and automatically calculating deadlines for the identified events based on these court-specific rules, the calendaring system may eliminate the need for manual calculations and reduces the risk of errors or missed deadlines. In one or more embodiments, the automated court-rule based calendaring system May be implemented as a service that can be accessed (e.g., via network 120) by the docketing system using, e.g., webhooks, API calls, and the like. The rule-based calendaring system tracks the (e.g., necessary) deadlines and child events related to a specific trigger or parent event and specific jurisdiction. A child event may be an event that is triggered or initiated responsive to a parent event being update, created, completed, or the like. The user of the docketing system can interact with the docketing system to make an API call to the appropriate endpoint of the rule-based calendaring system and pass, e.g., the jurisdiction and the parent event name or trigger name, in the API call. The trigger names for which a response may be received from the calendaring system may be standardized and a predetermined mapping may be defined between the triggerable event types that can be selected by the user under the matter schedule type and the corresponding standardized event triggers defined by the calendaring system for which child events and deadlines can be retrieved.

The rule-based calendaring system may provide a response representing the child events and corresponding deadlines based on the parent triggering event in a standardized file format such as a Javascript Object Notation (JSON) file. The docketing system 130 (e.g., via docket generator module 201) can thus create a docket for a particular matter that includes events (e.g., parent events, child events) and corresponding deadlines based on the jurisdiction corresponding to the matter and using, e.g., data received in response to an API call to the automated rule-based calendaring system.

Event or event information for an event entered manually by a user is prone to error. For example, a docket includes a trigger event with a date and corresponding child events responsive to the trigger event. If the date for the trigger event or type of trigger event was entered incorrectly by a user (e.g., user selecting “Hearing” as opposed to “Motion” from a dropdown list, or entering the wrong deadline date), then subsequent child events and corresponding deadlines may be consequently entered incorrectly in the created docket. Such an error may increase the risk of costly errors or missed deadlines. To overcome the above problems, docketing system 130 is configured to integrate a court docket from a court system (e.g., via API calls) and utilize the court docket as “ground truth” to verify the corresponding docket created by docketing system 130 (e.g., docket generator module 201). For example, docket management module 213 uses an event extracted from a court system to verify information for a docket event (e.g., event 405), such as the event name, type, date, and time. Additionally, or alternatively, docket management module 213 can identify errors, discrepancies, or mismatches and perform operations to fix the identified issues.

### Docket Matching Application

Docket matching application 215 can embed real-time court data and alerts from legal LDaaS system 140 directly into the docketing system 130, enhancing efficiency and data accuracy of the docketing system 130. As previously described, an LDaaS system 140 may provide real-time access to comprehensive and normalized court records from one or more court systems corresponding to federal, state, or local courts, or government agencies. LDaaS system 140 may enable the docketing system 130 to efficiently track, analyze, and utilize court data from different jurisdictions for various purposes including, e.g., verifying the accuracy of the internal docket events created by the users of the docketing system 130 (e.g., that used court correspondence (e.g., received via first class mail) and the calendaring system). The LDaaS system 140 may be configured to automatically notify subscribers, (e.g., via subscribed API endpoints) such as docketing system 130, of any updates or changes to a status of a case. This enables the docketing system 130 to access up-to-date case information, created dockets, filings, judgments, and other relevant documents of a particular case in real time.

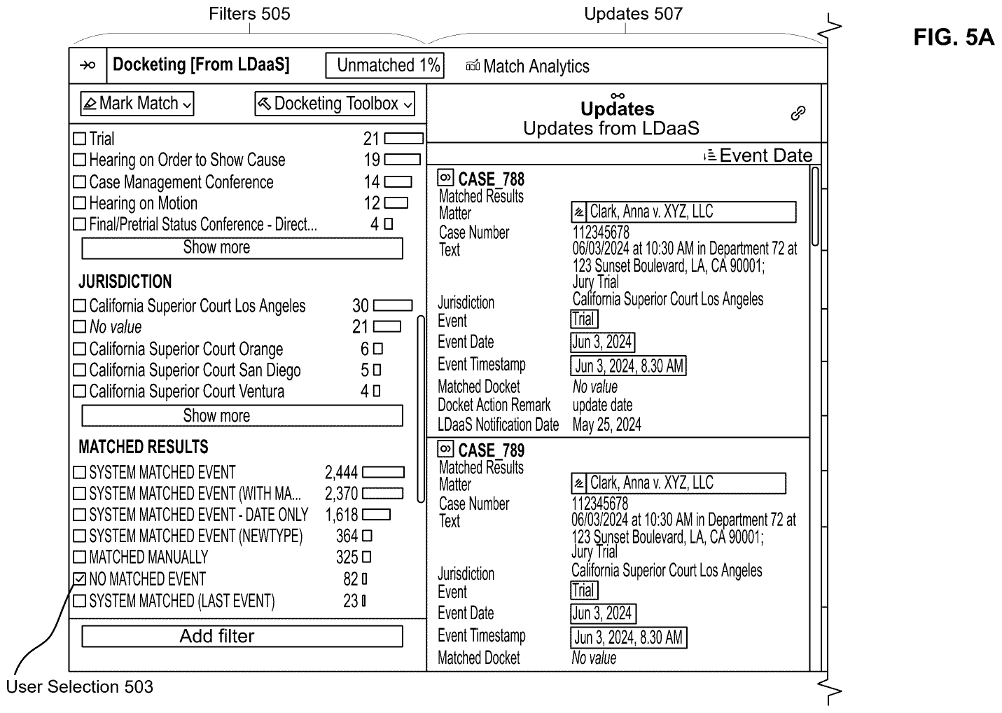

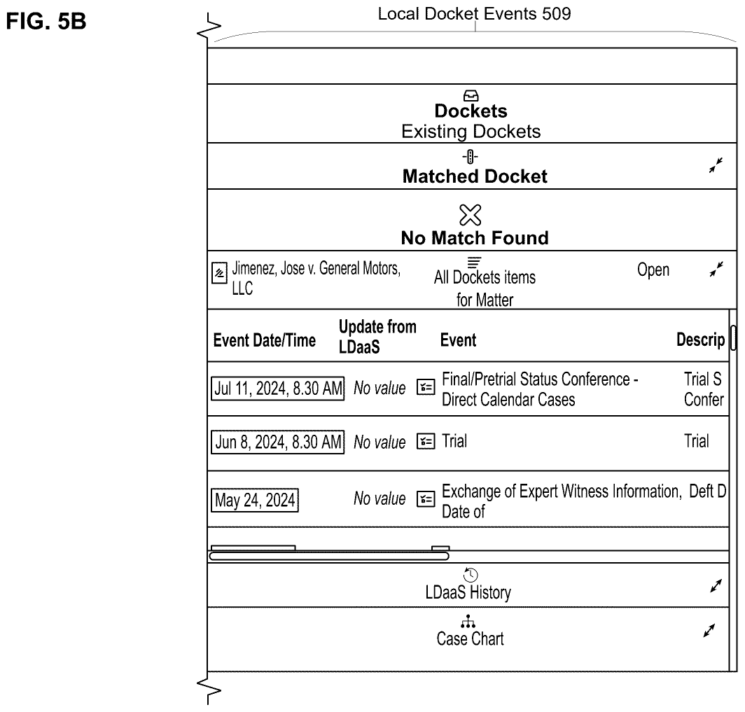

LDaaS system 140 may send updates for a matter every time a relevant court has event updates for that matter. After an update is received, rather than the user of the docketing system 130 having to manually update internal docket events based on the received data structure (e.g., including information from court records), the docket matching application 215 can automatically match internal docket events (e.g., created by docket generator module 201 (e.g., particulars of the events shown in FIG. 4)) with external event updates that came from the LDaaS system 140, allowing automatic updates to the internal docket of the docketing system 130. In addition, the docket matching application 215 may allow users via a UI to manually match updates (e.g., received as a JSON file in response to an API call) with internal events (e.g., shown in FIGS. 5A and 5B) in case a match is not made by mapping module 209, thereby allowing new mappings to be made so that future instances of similar mismatches get matched automatically. Docketing system 130 also allows for UI visualizations on auto-matches made by mapping module 209, to help ensure accurate docketing, metric tracking, and/or reporting.

FIGS. 5A and 5B (“FIG. 5” collectively) illustrate an example docket system “matching” user interface, in accordance with an embodiment (FIG. 5A is the left side of the user interface and FIG. 5B is right side of the user interface). A matching user interface allows a user to view and interface matches made (or not made) by mapping module 209 between local and external events. As shown in FIG. 5, the matching user interface includes filters 505 (left pane) based on which a user can drill down on. For example, FIG. 5 shows the user has selected 503 “No Matched Event.” In the situation of FIG. 5, the middle pane of the UI shows event updates 507 for a matter that were received from LDaaS system 140, where a corresponding matter exists in docketing system 130, but the mapping module 209 was unable to match the event updates 507 to events in the local docket for that corresponding matter. Local docket events 509 for the corresponding matter are illustrated in the right pane of FIG. 5.

In one or more embodiments, the LDaaS system 140 may expose one or more API endpoints (e.g., court specific or jurisdiction specific endpoints) that the docketing system 130 can subscribe to. The docketing system 130 may be configured to automatically make (e.g., periodically or based on predetermined conditions) API calls to a specific API endpoint (e.g., a court specific endpoint) to receive (e.g., as a JSON file) the court dockets for matters where there is an event update. The docketing system 130 (e.g., via mapping module 209) may compare, e.g., the matter number and jurisdiction of the received matter with the matter number and jurisdiction of a locally stored matter, and if there is a match, the docketing system 130 (e.g., via docket management module 213) may perform a comparison (e.g., a text comparison) between the court docket for the matter and the local docket. For every event or trigger in the received court docket, the docketing system 130 (e.g., via mapping module 209) may be configured to determine whether there is a match with an event or trigger in the local docket. In determining whether there is a match, the mapping module 209 may compare the event type, the deadline date, the time, and the text description of the event. In making the comparison for the event type, the mapping module 209 may refer to a mapping table that stores a mapping between the standardized docket name for the event type of the locally stored event with the standardized name for the event or trigger type of the court docket received from the LDaaS system 140. Different courts or jurisdictions may refer to different triggers or docket events with different names, but they may be mapped to different standardized docket names in the docketing system 130 (e.g., based on the standardized trigger names used by the automated court rules-based calendaring system). To create standardization and to apply the nomenclature that has been defined by the docketing system (and that is used by its users) to mean certain things and have corresponding workplans, the mapping module 209 can maintain a mapping of the current match terms between the LDaaS system 140 and the docketing system 130.

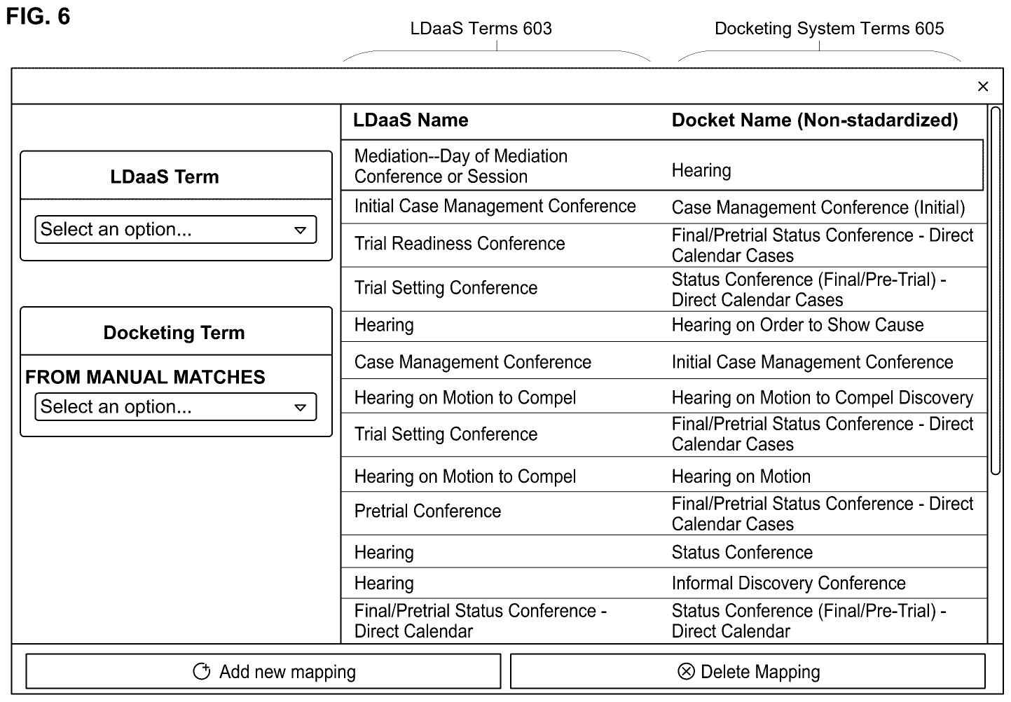

FIG. 6 is a user interface illustrating example mappings of mapping module 209, in accordance with an embodiment. More specifically, FIG. 6 illustrates example mappings listing current match terms between LDaaS system 140 and docketing system 130 (labeled as LDaaS Terms 603 and docketing system terms 605). For example, “Mediation-Day of mediation Conference or Session” is an LDaaS term 603 mapped to “Hearing,” which is a docketing system term. Without this mapping, “Mediation-Day of mediation Conference or Session” may be flagged as an unmatched event (e.g., if a docket entry in a received court docket lists an event type as “Mediation-Day of mediation Conference or Session”). The mappings of mapping module 209 (e.g., those shown in FIG. 6) may be created by users of the docketing system 130 over time. The user interface of FIG. 6 may also enable a user to search through existing matches or terms. It also allows the addition and deletion of mappings (e.g., by selecting the “add new mapping” element or “Delete Mapping” element).

If mapping module 209 is unable to match an event in an external docket (e.g., a court docket received from LDaaS system 140) with an event in a corresponding local docket, the external event may be displayed to a user via an interface. The user may manually review the external event and identify a corresponding local event (e.g., based on the date and time of the event, based on the jurisdiction, and based on user's work experience). The user may indicate a matching between the events (e.g., indicating they are the same event type), thus indicating any updates in the external docket for this event should be applied to the corresponding local event in the local docket (e.g., update the trigger deadline date in the local docket). However, if mapping module 209 already includes the proper mapping, the system already “knows” that these two events refer to the same thing, and as a result, the system matches them automatically, applies the event update, if any, and does not flag this mapping for manual review, thereby saving time and increasing efficiency.

Any corrections made to the local docket based on the court docket not only improve the accuracy of the local docket (and help ensure accuracy of child event calendar deadlines created based on an event trigger), but also have the added benefit of automatically identifying the docketing system user who is responsible for the data entry error and tracking repeat offenders.

As new unmatched events are encountered and these unmatched events are reviewed and resolved by users of the docketing system 130 (e.g., via an interface), new match terms may be identified and added to the mapping table of mapping module 209 (e.g., the mapping table illustrated in FIG. 6). For example, for an unmatched court docket event, a user may select an existing event in the local docket as the one it should be mapped to. Based on this mapping, the system may automatically associate the event type of the matched events as a new entry in the mapping table of FIG. 6. As a result, the next time when the docketing system 130 receives an instance of a similar matching, the docketing system 130 can automatically resolve the discrepancy and recognizes the court docket event (having a particular name) as corresponding to a local docket event (e.g., having a different name), based on the matching terms or mapping stored in the mapping table. The mapped (corrected) trigger items in the local docket for the matter may then be used by the system to apply the calendar rules to generate additional events, e.g., child events, while ensuring accuracy of the calculated deadlines for all the events.

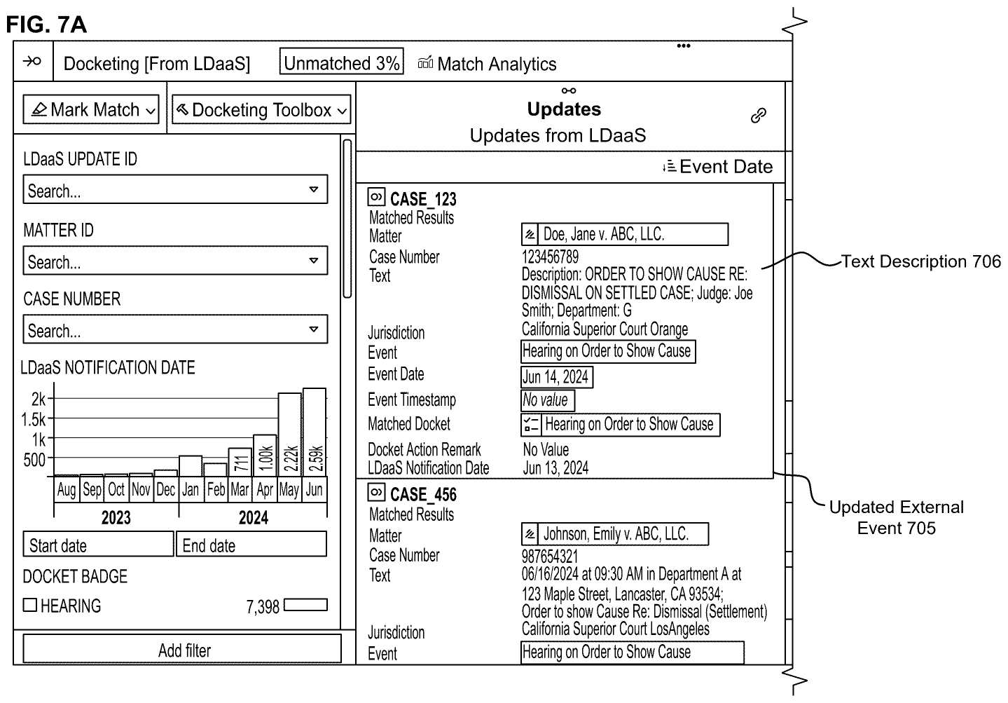

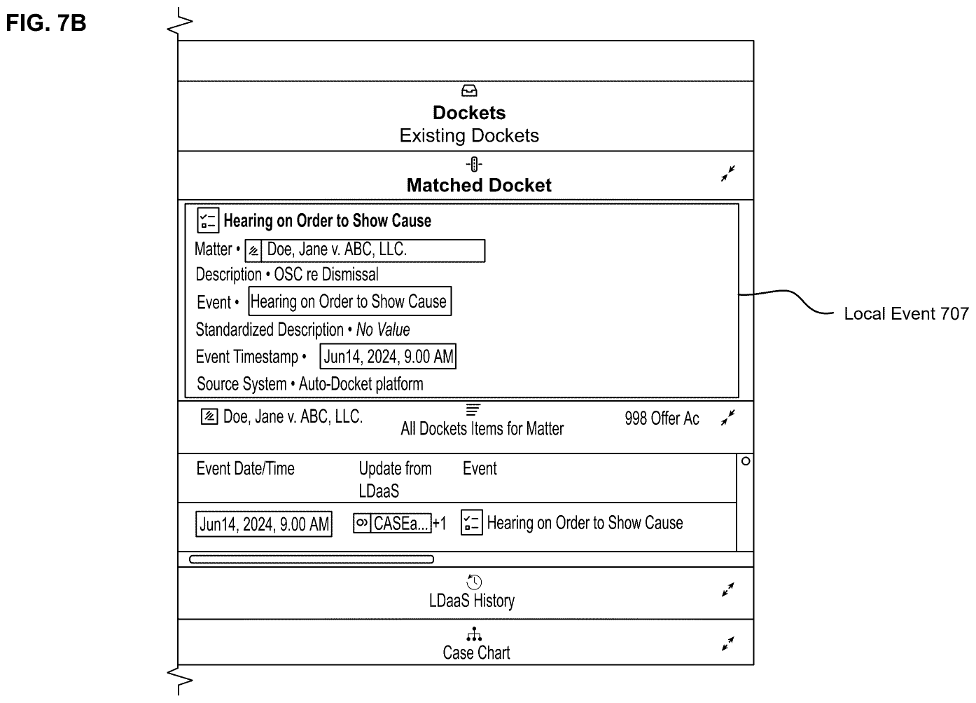

FIGS. 7A and 7B (“FIG. 7” collectively) illustrate another example matching user interface, in accordance with an embodiment (FIG. 7A is the left side of the user interface and FIG. 7B is right side of the user interface). FIG. 7 is similar to FIG. 5, except in this example, the right pane of local docket events shows a local event 707 matched (via mapping module 209) with an updated external event 705 in the middle pane. As shown in FIG. 7, the data structure received from the LDaaS system 140 as an API payload includes text description indicating among other information, the name of the judge assigned to the case. Based on this information, the docketing system 130 may automatically update the local event in the local docket to include the text description 706 and present this information to the appropriate users (e.g., a working attorney assigned to the case) via the user interface of the docketing system 130.

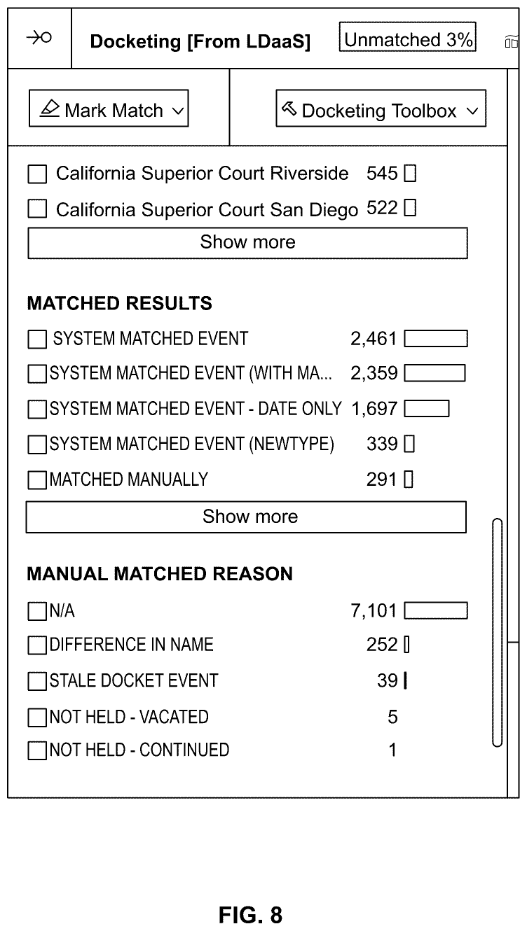

FIG. 8 is a zoomed in view of a left pane of a matching user interface, in accordance with an embodiment. As previously described, the left pane allows a user to select which events to view by selecting one or more boxes on the left-hand side of the left pane. Said differently, the left pane allows a user to filter updates received from LDaaS system 140 (which will be displayed in the middle pane) and any corresponding local events (which will be displayed on the right pane).

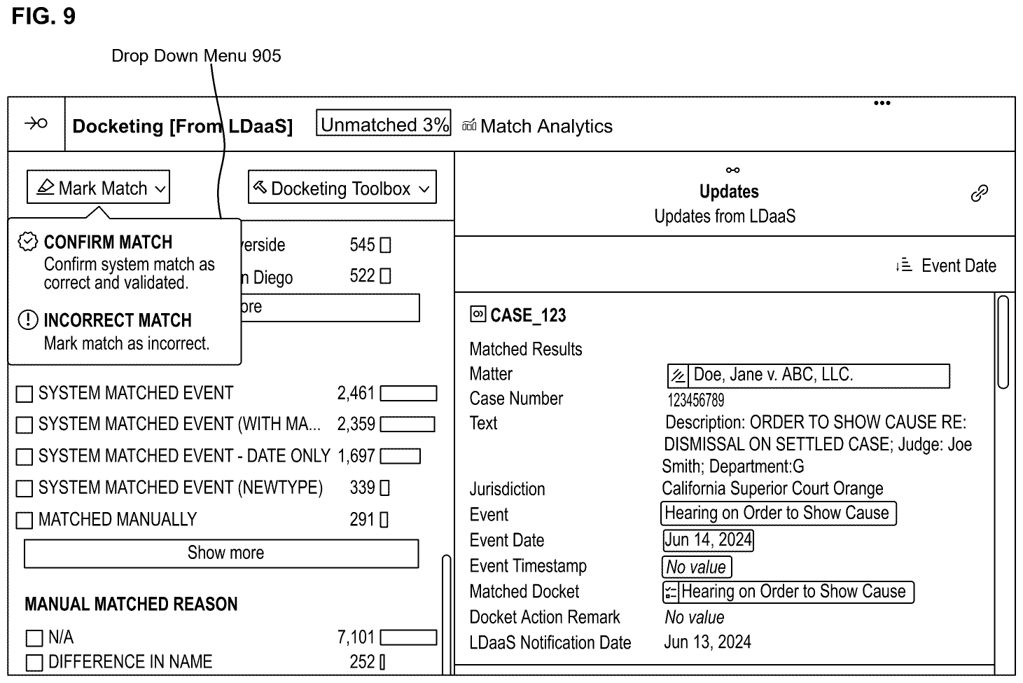

FIG. 9 is a magnified view of an upper left portion of a matching user interface (similar to the user interface of FIG. 7), in accordance with an embodiment. FIG. 9 illustrates drop down menu 905 for the “mark match” element (e.g., button). The drop down menu 905 of the mark match element allows a user to assign an update in the middle pane as a correct or an incorrect match with a local event (by selecting “Confirm Match” or “Incorrect Match”).

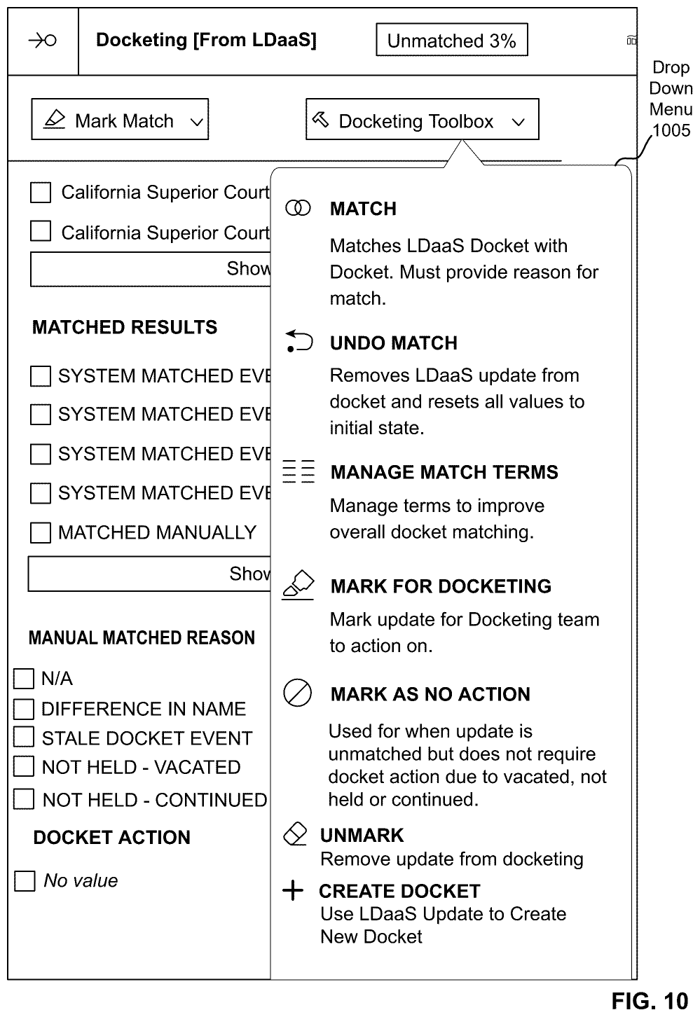

FIG. 10 is another magnified view of an upper left portion of a matching user (similar to the user interface of FIG. 7), in accordance with an embodiment. FIG. 10 additionally illustrates drop down menu 1005 for the “Docketing Toolbox” element (e.g., button). The “match” element in the drop down menu 1005, enables a user to match an update with local docket event. In this example, if a user makes this selection, they will also need to provide a reason for the matching. The “undo match” element, enables a user to un-match an update from a local docket event. Selecting this may include docketing system 103 resetting matching values to the initial state before the match was first made (e.g., by the user or another user). Selecting the “manage match terms” element may result in the user interface displaying an overlay that shows matching terms of mapping module 209 between external and local events (e.g., the interface of FIG. 6).

### Example Methods

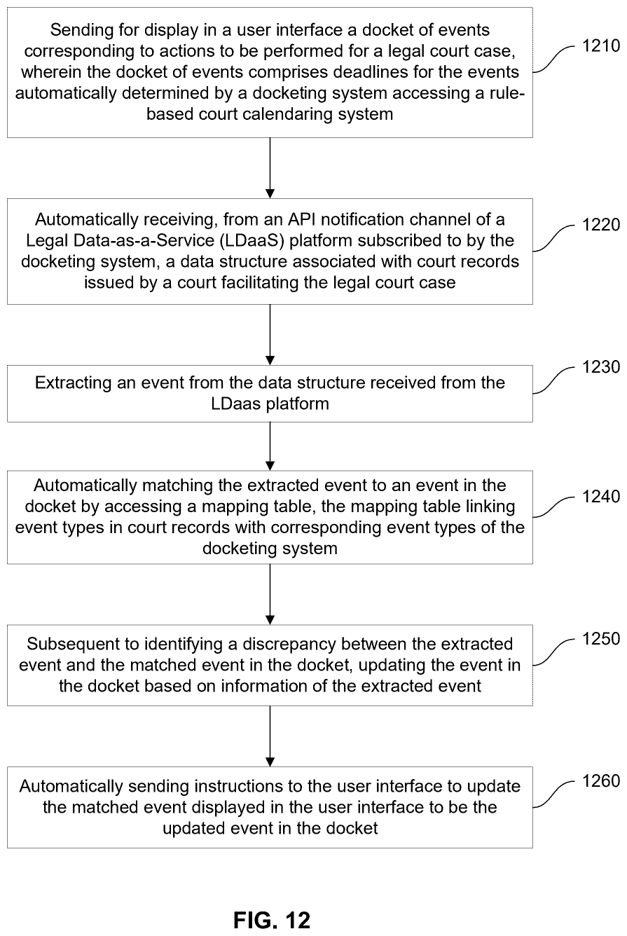

FIG. 12 is a flow chart illustrating a method for improved user interfaces and systems for automatic docket management and event updating within a legal case management system, in accordance with an embodiment. The steps of the method may be performed in different orders, and the method may include different, additional, or fewer steps. The steps of the method are described as being performed by docketing system 130, however this is not required.

At step 1210, docketing system (e.g., via UI module 211) sends for display (or displays) in a user interface a docket of events (e.g., generated by docket generator module 201) corresponding to actions to be performed for a legal court case, wherein the docket of events comprises (e.g., statutory and/or court case) deadlines for the events automatically determined by a docketing system accessing a rule-based court calendaring system (e.g., calendaring module 203).

At step 1220, docketing system (e.g., via communication module 205) automatically (e.g., periodically or responsive to an update from the LDaaS system 140) receives, (e.g., an API call or webhook) from an API notification channel of the LDaaS system 140 subscribed to by the docketing system 130, a data structure associated with court records issued by a court facilitating the legal court case. A data structure may refer to a format for organizing, managing, and storing data for access and modification.

At step 1230, docketing system (e.g., via extractor module 207) extracts an event from the data structure received from the LDaaS system 140.

At step 1240, docketing system (e.g. via, mapping module 209) automatically matches the extracted event to an event in the docket by accessing a mapping table, the mapping table linking event types in court records with corresponding event types of the docketing system 103.

At step 1250, docketing system (e.g., via docket management module 213), subsequent (e.g., responsive) to identifies a discrepancy between the extracted event and the matched event in the docket, updates the event in the docket based on information of the extracted event.

At step 1260, docketing system (e.g., via UI module 211) automatically sends instructions to the user interface to update the matched event displayed in the user interface to be the updated event in the docket. In some embodiments, prior to updating the matched event, the docketing system 130 sends the discrepancy and/or the update to the user for display by the user interface. The update may then be implemented responsive to the user confirms the update (e.g., by interacting with the interface).

In some aspects, the techniques described herein relate to a method, further including: extracting a second event from the data structure received from the LDaaS system; automatically matching the second extracted event to a second event in the docket by accessing the mapping table; and subsequent to matching the second extracted event to the second event in the docket, verifying the accuracy of the second event in the docket based on the second extracted event (e.g., confirming information of the second event (e.g., the event date) is the same as, similar to, and/or consistent with information of the second extracted event).

In some aspects, the techniques described herein relate to a method, wherein updating the event in the docket includes modifying the deadline for the event in the docket.

In some aspects, the techniques described herein relate to a method, further including: extracting a second event from the data structure received from the LDaaS system; automatically attempting to match the second extracted event to one or more events in the docket by accessing the mapping table; subsequent to the second extracted event not having a matching event in the docket, sending the second extracted event for display to a user via the user interface; receiving, from the user, a confirmation the second extracted event does not have a matching event in the docket; (e.g., automatically) generating a new event for the docket based on the second extracted event, the new event having a deadline based on information of the second extracted event; and automatically sending instructions to the user interface for the docket of events displayed by the user interface to include the new event.

In some aspects, the techniques described herein relate to a method, further including: extracting a second event from the data structure received from the LDaaS system; automatically attempting to match the second extracted event to one or more events in the docket by accessing the mapping table; subsequent to the second extracted event not having a matching event in the docket, sending the second extracted event for display to a user via the user interface; receiving, from the user, an indication of an update to the mapping table, the mapping update mapping the second extracted event to a second event in the docket; and matching the second extracted event to the second event in the docket.

In some aspects, the techniques described herein relate to a method, further including: automatically receiving, from the API notification channel of the LDaaS system, a second data structure associated with court records issued by the court facilitating the legal court case; extracting a third event from the second data structure received from the LDaaS system; and automatically matching the third extracted event to the second event in the docket using the using the mapping update in the mapping table.

In some aspects, the techniques described herein relate to a method, further including: updating information of the second event in the docket based on information of the third extracted vent.

In some aspects, the techniques described herein relate to a method, further including: subsequent to sending instructions to the user interface to update the matched event, receiving user feedback; and responsive to the user feedback indicating the update is not accurate, revising the updated event.

In some aspects, the techniques described herein relate to a method, further including: extracting an update to the legal court case from the data structure received from the LDaaS system; sending the update to the legal court case to the user interface for display; and subsequent to receiving an update confirmation, revising the docket of events including at least one of: deleting one or more events, modifying one or more events, or generating one or more new events for the docket.

Some embodiments relate to a method comprising: running an API call to a court system to obtain a set of actions in a court docket corresponding to a particular matter; for each action in the set of actions in the court docket, identifying a match in a local docket corresponding to the particular matter; in response to identifying a discrepancy between an action in the court docket and a matching action in the local docket, updating the action in the local docket; in response to not identifying the match for the action in the court docket, consulting a mapping table storing a mapping between names of actions in the court docket with names of actions in the local docket; in response to not identifying a relevant mapping in the mapping table, flagging the action in the court docket for user review; and based on a result of the user review, updating the mapping table by adding a new mapping between a name of the action in the court docket with a name of the action in the local docket; wherein the updated mapping table automatically identifies as a match, future similar instances of the new mapping between the court docket and the local docket.

Other aspects include components, devices, systems, improvements, methods, processes, applications, (e.g., non-transitory) computer readable mediums, and other technologies related to any of the above.

### Additional Considerations

Some portions of the preceding detailed descriptions have been presented in terms of algorithms and symbolic representations of operations on data bits within a computer memory. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof. The software modules described herein may be embodied as program code (e.g., software comprised of instructions stored on non-transitory computer readable storage medium and executable by at least one processor) and/or hardware (e.g., application specific integrated circuit (ASIC) chips or field programmable gate arrays (FPGA) with firmware). The modules correspond to at least having the functionality described herein when executed/operated.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

A processing device as described herein (e.g., processor 1102) may include one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. The processing device may be configured to execute instructions for performing the operations and steps described herein. A controller or microcontroller as described herein may include one or more processors, such as a central processing unit, internal memory, and input/output components. The controller may communicatively couple processing devices such that one processing device may manage the operation of another processing device through the controller. A controller may be communicatively coupled to a processing device through a CAN bus.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. In addition, use of the “a” or “an” are employed to describe elements and components of the embodiments herein. This description should be read to include one or at least one and the singular also includes the plural unless it is obvious that it is meant otherwise.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for monitoring implements during automated operations through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

### Example Machine Architecture

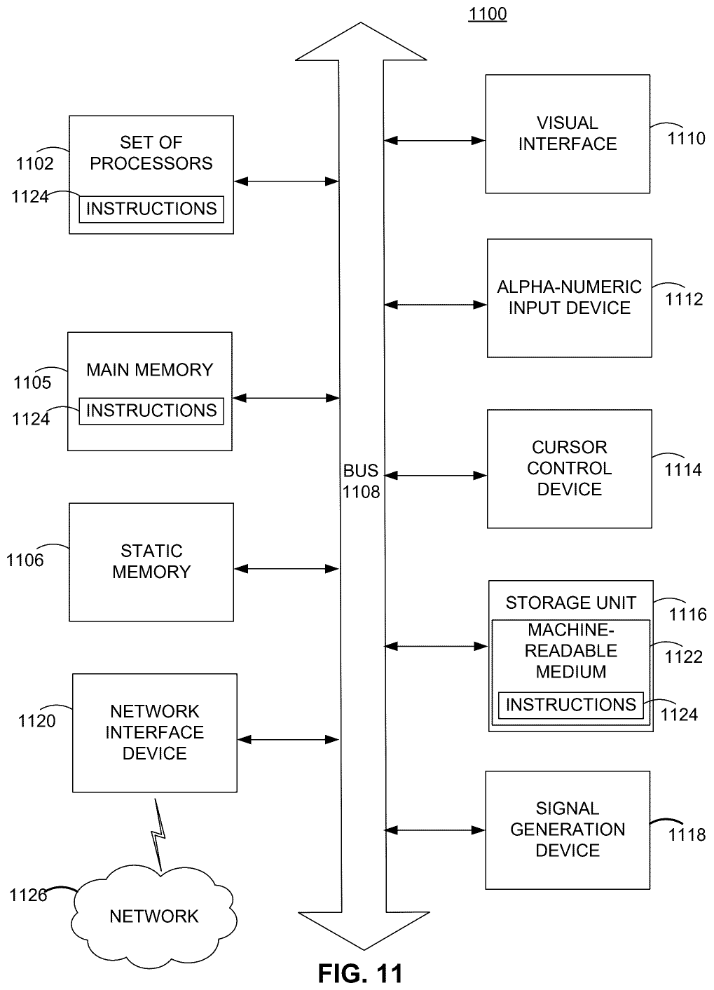

FIG. 11 is a block diagram illustrating components of an example machine for reading and executing instructions from a machine-readable medium, in accordance with one or more example embodiments. Specifically, FIG. 11 shows a diagrammatic representation of client device 110, docketing system 130, or LDaaS system 140 of FIG. 1, in the example form of a computer system (also “computing device”) 1100.

The computer system 1100 can be used to execute instructions 1124 (e.g., program code or software) for causing the machine to perform any one or more of the methodologies (or processes) or modules described herein. In alternative embodiments, the machine operates as a standalone device or a connected (e.g., networked) device that connects to other machines. In a networked deployment, the machine may operate in the capacity of a server machine or a client machine in a client-server network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 1124 (sequential or otherwise) that specify actions to be taken by that machine. Further, while only a single machine is illustrated, the term “machine” shall also be taken to include any collection of machines that individually or jointly execute instructions 1124 to perform any one or more of the methodologies discussed herein.

The example computer system 1100 includes a set of one or more processing units (generally processor 1102). The processor 1102 is, for example, one or more central processing units (CPUs), one or more graphics processing units (GPUs), one or more digital signal processors (DSPs), one or more control systems, one or more state machines, one or more application specific integrated circuits (ASICs), one or more radio-frequency integrated circuits (RFICs), or any combination of these. If processor 1102 includes two or more processing units, the processing units may work individually or collectively to perform a set of one or more operations or tasks. The computer system 1100 also includes a main memory 1104. The computer system may include a storage unit 1116. The processor 1102, memory 1104, and the storage unit 1116 communicate via a bus 1108.

In addition, the computer system 1100 can include a static memory 1106, a graphics display 1110 (e.g., to drive a plasma display panel (PDP), a liquid crystal display (LCD), or a projector). The computer system 1100 may also include an alphanumeric input device 1112 (e.g., a keyboard), a cursor control device 1117 (e.g., a mouse, a trackball, a joystick, a motion sensor, or other pointing instrument), a signal generation device 1118 (e.g., a speaker), and a network interface device 1120, which also are configured to communicate via the bus 1108.

The storage unit 1116 includes a machine-readable medium 1122 on which is stored instructions 1124 (e.g., software) embodying any one or more of the methodologies or functions described herein. For example, the instructions 1124 may include the functionalities of components, stores, or modules of docketing system 130. The instructions 1124 may also reside, completely or at least partially, within the main memory 1104 or within the processor 1102 (e.g., within a processor's cache memory) during execution thereof by the computer system 1100, the main memory 1104 and the processor 1102 also constituting machine-readable media. The instructions 1124 may be transmitted or received over a network 1126 via the network interface device 1120.

What is claimed is:

1. A computer-implemented method, comprising:
sending for display in a user interface a docket of events corresponding to actions to be performed for a legal court case, wherein the docket of events comprises deadlines for the events automatically determined by a docketing system accessing a rule-based court calendaring system;
automatically receiving, from an API notification channel of a Legal Data-as-a-Service (LDaaS) system subscribed to by the docketing system, a data structure associated with court records issued by a court facilitating the legal court case;
extracting an event from the data structure received from the LDaaS system;
automatically matching the extracted event to an event in the docket by accessing a mapping table, the mapping table linking event types in court records with corresponding event types of the docketing system;
subsequent to identifying a discrepancy between the extracted event and the matched event in the docket, updating the event in the docket based on information of the extracted event; and
automatically sending instructions to the user interface to update the matched event displayed in the user interface to be the updated event in the docket.

2. The method of claim 1, further comprising:
extracting a second event from the data structure received from the LDaaS system;
automatically matching the second extracted event to a second event in the docket by accessing the mapping table; and
subsequent to matching the second extracted event to the second event in the docket, verifying the accuracy of the second event in the docket based on the second extracted event.

3. The method of claim 1, wherein updating the event in the docket comprises modifying the deadline for the event in the docket.

4. The method of claim 1, further comprising:
extracting a second event from the data structure received from the LDaaS system;
automatically attempting to match the second extracted event to one or more events in the docket by accessing the mapping table;
subsequent to the second extracted event not having a matching event in the docket, sending the second extracted event for display to a user via the user interface;
receiving, from the user, a confirmation the second extracted event does not have a matching event in the docket;
generating a new event for the docket based on the second extracted event, the new event having a deadline based on information of the second extracted event; and
automatically sending instructions to the user interface for the docket of events displayed by the user interface to include the new event.

5. The method of claim 1, further comprising:
extracting a second event from the data structure received from the LDaaS system;
automatically attempting to match the second extracted event to one or more events in the docket by accessing the mapping table;
subsequent to the second extracted event not having a matching event in the docket, sending the second extracted event for display to a user via the user interface;
receiving, from the user, an indication of an update to the mapping table, the mapping update mapping the second extracted event to a second event in the docket; and
matching the second extracted event to the second event in the docket.

6. The method of claim 5, further comprising:
automatically receiving, from the API notification channel of the LDaaS system, a second data structure associated with court records issued by the court facilitating the legal court case;
extracting a third event from the second data structure received from the LDaaS system; and
automatically matching the third extracted event to the second event in the docket using the using the mapping update in the mapping table.

7. The method of claim 6, further comprising:
updating information of the second event in the docket based on information of the third extracted event.

8. The method of claim 1, further comprising:
subsequent to sending instructions to the user interface to update the matched event, receiving user feedback; and
responsive to the user feedback indicating the update is not accurate, revising the updated event.

9. The method of claim 1, further comprising:
extracting an update to the legal court case from the data structure received from the LDaaS system;
sending the update to the legal court case to the user interface for display; and
subsequent to receiving an update confirmation, revising the docket of events including at least one of: deleting one or more events, modifying one or more events, or generating one or more new events for the docket.

10. A non-transitory computer-readable storage medium storing instructions configured to, when executed by a computing device, cause the computing device to perform operations comprising:
sending for display in a user interface a docket of events corresponding to actions to be performed for a legal court case, wherein the docket of events comprises deadlines for the events automatically determined by a docketing system accessing a rule-based court calendaring system;
automatically receiving, from an API notification channel of a Legal Data-as-a-Service (LDaaS) system subscribed to by the docketing system, a data structure associated with court records issued by a court facilitating the legal court case;
extracting an event from the data structure received from the LDaaS system;
automatically matching the extracted event to an event in the docket by accessing a mapping table, the mapping table linking event types in court records with corresponding event types of the docketing system;
subsequent to identifying a discrepancy between the extracted event and the matched event in the docket, updating the event in the docket based on information of the extracted event; and
automatically sending instructions to the user interface to update the matched event displayed in the user interface to be the updated event in the docket.

11. The non-transitory computer-readable storage medium of claim 10, wherein the operations further comprise:
extracting a second event from the data structure received from the LDaaS system;
automatically matching the second extracted event to a second event in the docket by accessing the mapping table; and
subsequent to matching the second extracted event to the second event in the docket, verifying the accuracy of the second event in the docket based on the second extracted event.

12. The non-transitory computer-readable storage medium of claim 10, wherein updating the event in the docket comprises modifying the deadline for the event in the docket.

13. The non-transitory computer-readable storage medium of claim 10, wherein the operations further comprise:
extracting a second event from the data structure received from the LDaaS system;
automatically attempting to match the second extracted event to one or more events in the docket by accessing the mapping table;
subsequent to the second extracted event not having a matching event in the docket, sending the second extracted event for display to a user via the user interface;
receiving, from the user, a confirmation the second extracted event does not have a matching event in the docket;
generating a new event for the docket based on the second extracted event, the new event having a deadline based on information of the second extracted event; and
automatically sending instructions to the user interface for the docket of events displayed by the user interface to include the new event.

14. The non-transitory computer-readable storage medium of claim 10, wherein the operations further comprise:
extracting a second event from the data structure received from the LDaaS system;
automatically attempting to match the second extracted event to one or more events in the docket by accessing the mapping table;
subsequent to the second extracted event not having a matching event in the docket, sending the second extracted event for display to a user via the user interface;
receiving, from the user, an indication of an update to the mapping table, the mapping update mapping the second extracted event to a second event in the docket; and
matching the second extracted event to the second event in the docket.

15. The non-transitory computer-readable storage medium of claim 14, wherein the operations further comprise:
automatically receiving, from the API notification channel of the LDaaS system, a second data structure associated with court records issued by the court facilitating the legal court case;
extracting a third event from the second data structure received from the LDaaS system; and
automatically matching the third extracted event to the second event in the docket using the using the mapping update in the mapping table.

16. The non-transitory computer-readable storage medium of claim 15, wherein the operations further comprise:
updating information of the second event in the docket based on information of the third extracted vent.

17. The non-transitory computer-readable storage medium of claim 10, wherein the operations further comprise:
subsequent to sending instructions to the user interface to update the matched event, receiving user feedback; and
responsive to the user feedback indicating the update is not accurate, revising the updated event.

18. The non-transitory computer-readable storage medium of claim 10, wherein the operations further comprise:
extracting an update to the legal court case from the data structure received from the LDaaS system;
sending the update to the legal court case to the user interface for display; and
subsequent to receiving an update confirmation, revising the docket of events including at least one of: deleting one or more events, modifying one or more events, or generating one or more new events for the docket.

19. A system comprising:
a set of one or more processors; and
a computer-readable storage medium storing instructions configured to, when executed by the set of one or more processors, cause the set of one or more processors to perform operations comprising:
sending for display in a user interface a docket of events corresponding to actions to be performed for a legal court case, wherein the docket of events comprises deadlines for the events automatically determined by a docketing system accessing a rule-based court calendaring system;
automatically receiving, from an API notification channel of a Legal Data-as-a-Service (LDaaS) system subscribed to by the docketing system, a data structure associated with court records issued by a court facilitating the legal court case;
extracting an event from the data structure received from the LDaaS system;
automatically matching the extracted event to an event in the docket by accessing a mapping table, the mapping table linking event types in court records with corresponding event types of the docketing system;
subsequent to identifying a discrepancy between the extracted event and the matched event in the docket, updating the event in the docket based on information of the extracted event; and
automatically sending instructions to the user interface to update the matched event displayed in the user interface to be the updated event in the docket.

20. The system of claim 19, wherein the operations further comprise:
extracting a second event from the data structure received from the LDaaS system;
automatically matching the second extracted event to a second event in the docket by accessing the mapping table; and
subsequent to matching the second extracted event to the second event in the docket, verifying the accuracy of the second event in the docket based on the second extracted event.
